(19) United States
(12) Patent Application Publication
(10) Pub. No.: US 2018/0279273 A1
(43) Pub. Date: Sep. 27, 2018

(54) Downlink Control Signal Design In Mobile Communications

(71) Applicant: MediaTek Inc., Hsinchu City (TW)

(72) Inventors: Weidong Yang, San Diego, CA (US); Lung-Sheng Tsai, Hsinchu City (TW); Chien-Hwa Hwang, Hsinchu City (TW)

(21) Appl. No.: 15/933,591

(22) Filed: Mar. 23, 2018

Related U.S. Application Data
(60) Provisional application No. 62/476,684, filed on Mar. 24, 2017.
(60) Provisional application No. 62/502,562, filed on May 5, 2017.

(51) Int. Cl. H04W 72/04

(52) U.S. Cl. CPC H04W 72/042; H04W 72/0446

(57) ABSTRACT

Various solutions for downlink control signal design with respect to user equipment and network apparatus in mobile communications are described. An apparatus may receive a first downlink control signal from a first source. The apparatus may receive a second downlink control signal from a second source. The apparatus may further receive downlink data according to the first downlink control signal and the second downlink control signal. The first downlink control signal and the second downlink control signal may be identical. The first source and the second source may be different.

### CROSS REFERENCE TO RELATED PATENT APPLICATION(S)

The present disclosure is part of a non-provisional application claiming the priority benefit of U.S. Patent Application No. 62/476,684, filed on 24 Mar. 2017 and U.S. Provisional Patent Application Ser. No. 62/502,562, filed on 5 May 2017. The contents of the aforementioned patent documents are herein incorporated by reference in their entirety.

### TECHNICAL FIELD

The present disclosure is generally related to mobile communications and, more particularly, to downlink control signal design with respect to user equipment and network apparatus in mobile communications.

### BACKGROUND

Unless otherwise indicated herein, approaches described in this section are not prior art to the claims listed below and are not admitted as prior art by inclusion in this section.

There are various well-developed and well-defined cellular communications technologies in telecommunications that enable wireless communications using mobile terminals, or user equipment (UE). For example, the Global System for Mobile communications (GSM) is a well-defined and commonly used communications system, which uses time division multiple access (TDMA) technology, which is a multiplex access scheme for digital radio, to send voice, video, data, and signaling information (such as a dialed telephone number) between mobile phones and cell sites. The CDMA2000 is a hybrid mobile communications 2.5G/3G (generation) technology standard that uses code division multiple access (CDMA) technology. The UMTS (Universal Mobile Telecommunications System) is a 3G mobile communications system, which provides an enhanced range of multimedia services over the GSM system. The Long-Term Evolution (LTE), as well as its derivatives such as LTE-Advanced and LTE-Advanced Pro, is a standard for high-speed wireless communication for mobile phones and data terminals. In addition, there are some newly developed next generation communication technologies such as 5^{th} Generation (5G), New Radio (NR), Internet of Things (IoT) and Narrow Band Internet of Things (NB-IoT). These communication technologies are developed for higher speed transmission and serving for huge number of devices including machine type devices.

In order to allocate radio resources for transmitting downlink data to the UE, the network apparatus of the wireless communication system may have to transmit downlink control signals (e.g., physical downlink control channel (PDCCH)) to the UE first. The downlink control signal may indicate the resource allocation and the scheduling information of the downlink data. The UE may receive the downlink data according to the downlink control signals. In LTE, the downlink control signals are transmitted from a single network apparatus to the UE. However, in NR or newly developed next generation communication network, the downlink control signals may be transmitted from a plurality of sources (e.g., a plurality of network apparatus). The arrangement and distribution of the downlink control signals between the plurality of sources may become import and complicated. How to coordinate and transmit the downlink control signals among the plurality of sources is an important issue and has not been clearly defined.

Accordingly, it is important for the network apparatus and the UE to transmit and receive the downlink control signals in an efficient and reliable way. Therefore, in developing new communication systems, it is needed to provide proper design for the downlink control signal transmission.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to downlink control signal design with respect to user equipment and network apparatus in mobile communications.

In one aspect, a method may involve an apparatus receiving a first downlink control signal from a first source. The method may also involve the apparatus receiving a second downlink control signal from a second source. The method may further involve the apparatus receiving downlink data according to the first downlink control signal and the second downlink control signal. The first downlink control signal and the second downlink control signal may be identical. The first source and the second source may be different.

In one aspect, a method may involve an apparatus receiving a first downlink control signal from a first source in a first control resource set. The method may also involve the apparatus receiving a second downlink control signal from a second source in a second control resource set. The method may further involve the apparatus receiving downlink data according to the first downlink control signal and the second downlink control signal. The first control resource set and the second control resource set may be identical. The first source and the second source may be different.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a block diagram of an example communication apparatus and an example network apparatus in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to downlink control signal design with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

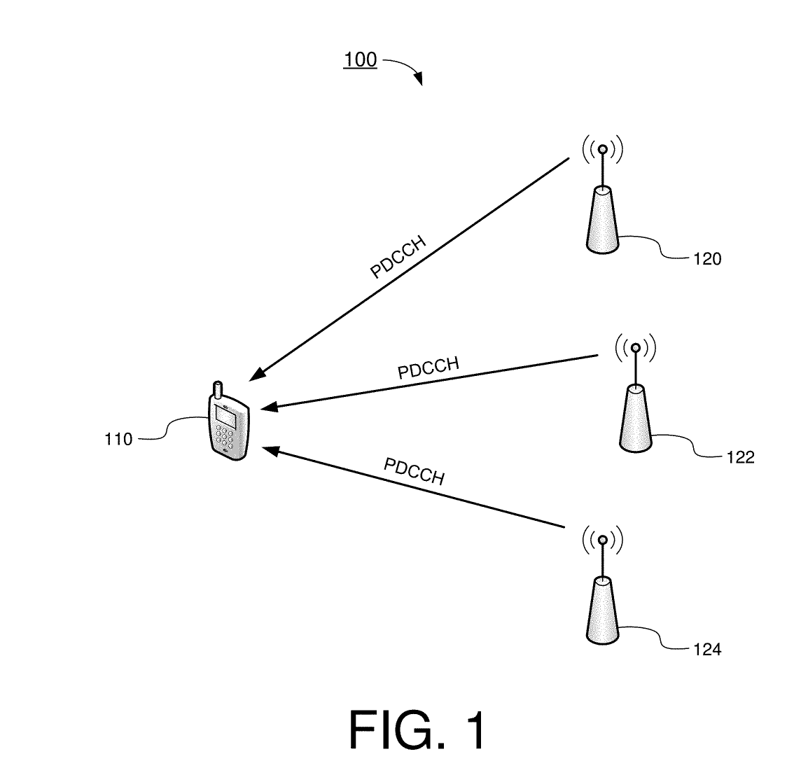

FIG. 1 illustrates an example scenario 100 under schemes in accordance with implementations of the present disclosure. Scenario 100 involves a user equipment (UE) 110 and a plurality of network apparatus 120, 122 and 124, which may be a part of a wireless communication network (e.g., a Long Term Evolution (LTE) network, a LTE-Advanced network, a LTE-Advanced Pro network, a 5^{th} Generation (5G) network, a New Radio (NR) network, an Internet of Things (IoT) network or a Narrow Band Internet of Things (NB-IoT) network). Each of the network apparatus 120, 122 and 124 may be considered as a transmit/receive point (TRP) of the wireless communication network. UE 110 may be able to receive a plurality of downlink data from the multiple TRPs. In order to properly transmit different downlink data, the multiple TRPs may be configured to transmit a plurality of downlink control signals to UE 110 to indicate the downlink data transmissions. The downlink control signal may comprise a physical downlink control channel (PDCCH). The PDCCH may comprise the scheduling information including, for example and without limitation, quasi co-location (QCL) assumptions for antenna ports, modulation and coding scheme (MCS) levels, hybrid automatic repeat request (HARQ) indices, resource allocations, etc. The multiple TRPs may be configured to use one single PDCCH or a plurality of PDCCHs to transmit all the scheduling information. The PDCCH generation rules or mechanisms may be aligned or coordinated among the multiple TRPs to reduce UE blind detection complexity.

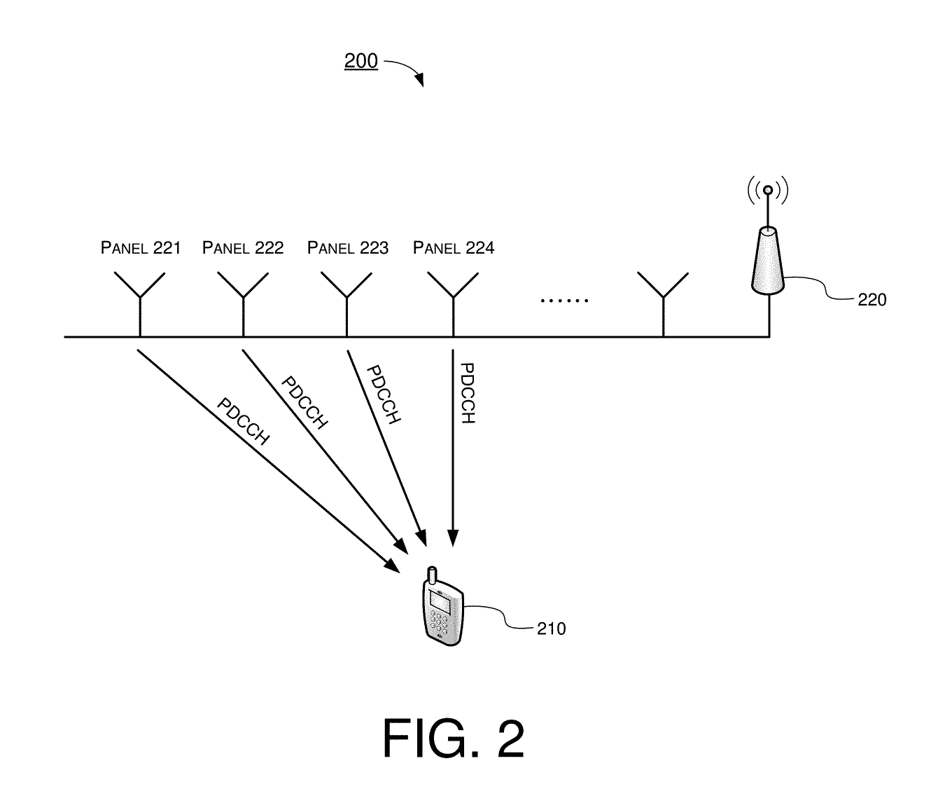

FIG. 2 illustrates an example scenario 200 under schemes in accordance with implementations of the present disclosure. Scenario 200 involves a user equipment (UE) 210 and a network apparatus 220, which may be a part of a wireless communication network (e.g., a Long Term Evolution (LTE) network, a LTE-Advanced network, a LTE-Advanced Pro network, a 5^{th} Generation (5G) network, a New Radio (NR) network, an Internet of Things (IoT) network or a Narrow Band Internet of Things (NB-IoT) network). Network apparatus 220 may comprise a plurality of panels 221, 222, 223, 224, etc. Each panel may comprise an antenna or a group of antennas for transmitting downlink signals to UE 210. UE 210 may be able to receive a plurality of downlink data from the multiple panels. In order to properly transmit different downlink data, the multiple panels may be configured to transmit a plurality of downlink control signals to UE 210 to indicate the downlink data transmissions. Similarly, the downlink control signal may comprise a physical downlink control channel (PDCCH). The PDCCH may comprise the scheduling information including, for example and without limitation, quasi co-location (QCL) assumptions for antenna ports, modulation and coding scheme (MCS) levels, hybrid automatic repeat request (HARQ) indices, resource allocations, etc. The multiple panels may be configured to use one single PDCCH or a plurality of PDCCHs to transmit all the scheduling information. The PDCCH generation rules or mechanisms may be aligned or coordinated among the multiple panels to reduce UE blind detection complexity.

In some implementations, the network side (e.g., the wireless communication network) may be configured to send the same downlink control information (DCI) contents to the UE (e.g., UE 110) from a plurality of TRPs (e.g., network apparatus 120, 122 or 124) in the form of a plurality of PDCCH transmissions. Specifically, the UE may be configured to receive a first downlink control signal (e.g., a first PDCCH) from a first source (e.g., a first TRP). The UE may also receive a second downlink control signal (e.g., a second PDCCH) from a second source (e.g., a second TRP). The contents of the first downlink control signal and the second downlink control signal may be identical and may indicate the resource allocation and the scheduling information of a plurality of downlink data. The UE may be configured to receive the downlink data according to the first downlink control signal and the second downlink control signal. Since multiple copies of the downlink control signal for the dame resource allocations are transmitted from different sources (e.g., different TRPs), a higher level of robustness for the downlink control signal may be achieved. The blockage issues or the fading effects of the control signal transmission may be mitigated.

Generally, the downlink control signal may be transmitted in a determined control resource set. The control resource set may occupy a specific time-frequency region of resource elements. In some implementations, the first downlink control signal may be transmitted in a first control resource set. The second downlink control signal may be transmitted in a second control resource set. The first control resource set and the second control resource set may be identical or different. For example, in a case that the first control resource set and the second control resource set are identical, the UE may be configured to receive/decode the first downlink control signal (e.g., the first PDCCH) from the first source (e.g., the first TRP) and the second downlink control signal (e.g., the second PDCCH) from the second source (e.g., the second TRP) in the same occasion. In a case that the first control resource set and the second control resource set are different, the UE may be configured to receive/decode the first downlink control signal (e.g., the first PDCCH) from the first source (e.g., the first TRP) in a first occasion of a slot (e.g., symbol 0) and decode the second downlink control signal (e.g., the second PDCCH) from the second source (e.g., the second TRP) in a second occasion of the slot (e.g., symbol 2). The intermediate occasion (e.g., symbol 1) may be reserved for the UE to perform receiving beam adjustment.

In some implementations, the network side (e.g., the wireless communication network) may be configured to send the same downlink control information (DCI) contents to the UE (e.g., UE 210) from a plurality of panels (e.g., panel 221, 222, 223 or 224) of a network apparatus (e.g., network apparatus 220) in the form of a plurality of PDCCH transmissions. Similarly, the UE may be configured to receive a first downlink control signal (e.g., a first PDCCH) from a first source (e.g., a first panel/TRP). The UE may also receive a second downlink control signal (e.g., a second PDCCH) from a second source (e.g., a second panel/TRP). The contents of the first downlink control signal and the second downlink control signal may be identical and may indicate the resource allocation and the scheduling information of a plurality of downlink data. The UE may be configured to receive the downlink data according to the first downlink control signal and the second downlink control signal. Since multiple copies of the downlink control signal for the dame resource allocations are transmitted from different sources (e.g., different panels or TRPs), a higher level of robustness for the downlink control signal may be achieved. The blockage issues or the fading effects of the control signal transmission may be mitigated.

In some implementations, the network side (e.g., the wireless communication network) may be configured to send the downlink control signals to the UE (e.g., UE 110) in the same control resource set across a plurality of TRPs (e.g., network apparatus 120, 122 or 124) in the form of a plurality of PDCCH transmissions. Specifically, the UE may be configured to receive a first downlink control signal (e.g., a first PDCCH) from a first source (e.g., a first TRP) in a first control resource set. The UE may also receive a second downlink control signal (e.g., a second PDCCH) from a second source (e.g., a second TRP) in a second control resource set. The time-frequency region of the first control resource set and the second control resource set may be identical. The first downlink control signal and the second downlink control signal may indicate the resource allocation and the scheduling information of a plurality of downlink data. The UE may be configured to receive the downlink data according to the first downlink control signal and the second downlink control signal. Since the first control resource set and the second control resource set are identical, the resource definition at some level such as control channel element (CCE) level may be common between the multiple sources (e.g., multiple TRPs). Alternatively, a control resource mapping rule (e.g., resource element group (REG)-to-control channel element (CCE)-DCI mapping rule) may also be defined. The UE may only need to perform blind detection of PDCCH in one control resource set for the plurality of PDCCHs from different sources (e.g., different TRPs). The blind detection complexity of PDCCH may be reduced and simplified.

In some implementations, the contents of the first downlink control signal (e.g., the first PDCCH) and the second downlink control signal (e.g., the second PDCCH) may be identical or different. For example, when the multiple sources (e.g., multiple TRPs) are configured with ideal backhaul, the multiple sources may be able to coordinate well and the contents of the downlink control signals from different sources may be identical. When the multiple sources (e.g., multiple TRPs) are not configured with ideal backhaul, the multiple sources may be independent from each other and the contents of the downlink control signals from different sources may be different. In a case that the first downlink control signal and the second downlink control signal are identical, the UE may receive/decode the same resource allocation and scheduling information for downlink data from different sources (e.g., different TRPs) in the same occasion. A higher level of robustness for the downlink control signal may be achieved. In a case that the first downlink control signal and the second downlink control signal are different, the UE may receive/decode different resource allocation and scheduling information for a plurality of downlink data from different sources (e.g., different TRPs) in the same occasion. The blind detection complexity of PDCCH may be reduced and simplified.

In some implementations, the network side (e.g., the wireless communication network) may be configured to send the downlink control signals to the UE (e.g., UE 210) in the same control resource set across a plurality of panels (e.g., panel 221, 222, 223 or 224) of a network apparatus (e.g., network apparatus 220) in the form of a plurality of PDCCH transmissions. Similarly, the UE may be configured to receive a first downlink control signal (e.g., a first PDCCH) from a first source (e.g., a first panel) in a first control resource set. The UE may also receive a second downlink control signal (e.g., a second PDCCH) from a second source (e.g., a second panel) in a second control resource set. The time-frequency region of the first control resource set and the second control resource set may be identical. The first downlink control signal and the second downlink control signal may indicate the resource allocation and the scheduling information of a plurality of downlink data. The UE may be configured to receive the downlink data according to the first downlink control signal and the second downlink control signal. Since the first control resource set and the second control resource set are identical, the resource definition at some level such as control channel element (CCE) level may be common between the multiple sources (e.g., multiple panels). The UE may only need to perform blind detection of PDCCH in one control resource set for the plurality of PDCCHs from different sources (e.g., different panels). The blind detection complexity of PDCCH may be reduced and simplified.

In some implementations, the UE may be able to use one DCI size to monitor a plurality of DCI types for reducing blind detection complexity. Specifically, the downlink control signal (e.g., the first PDCCH or the second PDCCH) may comprise an indication to indicate different DCI types. The indication may be a bit field in the DCI of the downlink control signal. The bit field may be a reserved bit field or a new bit field. The indication may be used to indicate a specific DCI type. For example, the DCI type may comprise a first DCI type indicating that the downlink data transmission is transmitted from a single source (e.g., a single TRP or a single panel). The DCI type may further comprise a second DCI type indicating that the downlink data transmission is transmitted from multiple sources (e.g., multiple TRPs or multiple panels). The DCI size of the first DCI type may be same as the DCI size of the second DCI type. Accordingly, the UE may be able to monitor different DCI with the same DCI size. Whether a DCI corresponds to a first DCI type or a second DCI type may be indicated by the bit field in the DCI. The UE may be configured to detect the DCI of the downlink control signal according to the indication. Since the DCI size of different DCI types are the same, the UE may be able to perform blind detection by using the same DCI size. The blind detection complexity of DCI may be reduced and simplified.

### Illustrative Implementations

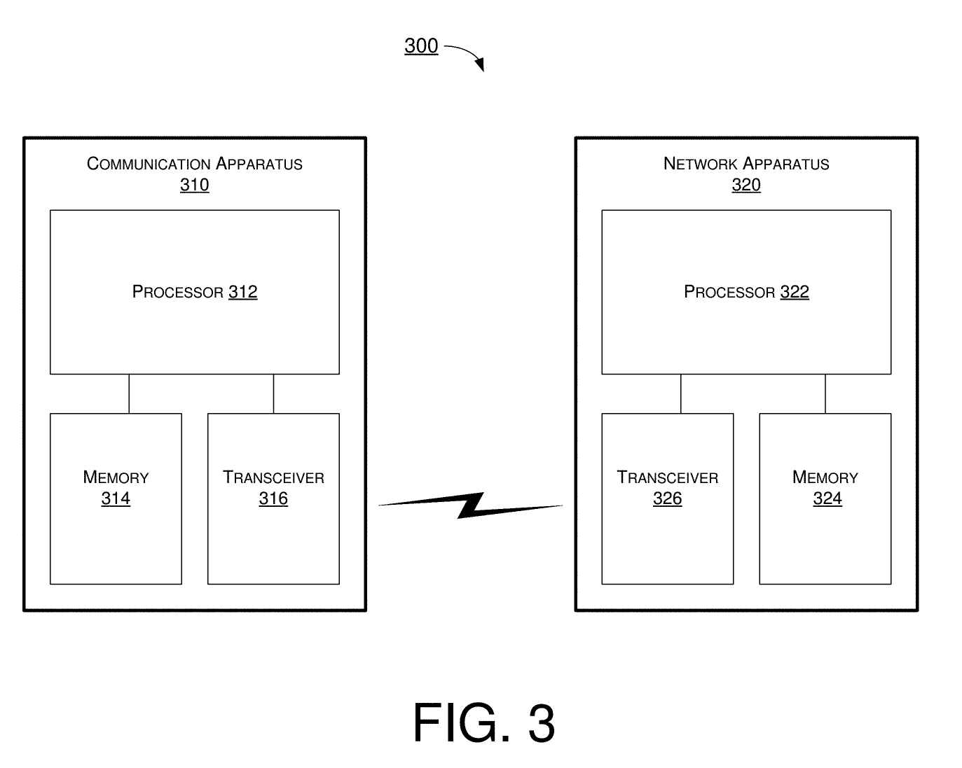

FIG. 3 illustrates an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to downlink control signal design with respect to user equipment and network apparatus in wireless communications, including scenarios 100 and 200 described above as well as processes 400 and 500 described below.

Communication apparatus 310 may be a part of an electronic apparatus, which may be a user equipment (UE) such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT or NB-IoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, or one or more complex-instruction-set-computing (CISC) processors. Communication apparatus 310 may include at least some of those components shown in FIG. 3 such as a processor 312, for example. communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a base station, a small cell, a router or a gateway. For instance, network apparatus 320 may be implemented in an eNodeB in a LTE, LTE-Advanced or LTE-Advanced Pro network or in a gNB in a 5G, NR, IoT or NB-IoT network. Alternatively, network apparatus 320 may be implemented in the form of one or more IC chips such as, for example and without limitation, one or more single-core processors, one or more multi-core processors, or one or more CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including power consumption reduction in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, network apparatus 320 may be considered as a transmit/receive point (TRP) of a wireless communication network or a wireless communication system. The wireless communication system may comprise a plurality of TRPs. Communication apparatus 310 may be able to receive a plurality of downlink data from the multiple TRPs of the wireless communication system. In order to properly transmit different downlink data, the wireless communication system may configure the multiple TRPs to transmit a plurality of downlink control signals to communication apparatus 310 to indicate the downlink data transmissions. The downlink control signal may comprise a physical downlink control channel (PDCCH). The PDCCH may comprise the scheduling information including, for example and without limitation, quasi co-location (QCL) assumptions for antenna ports, modulation and coding scheme (MCS) levels, hybrid automatic repeat request (HARQ) indices, resource allocations, etc. The wireless communication system may configure the multiple TRPs to use one single PDCCH or a plurality of PDCCHs to transmit all the scheduling information. The wireless communication system may align or coordinate the PDCCH generation rules or mechanisms among the multiple TRPs to reduce the blind detection complexity at communication apparatus 310.

In some implementations, network apparatus 320 may comprise a plurality of panels. Each panel may comprise an antenna or a group of antennas for transmitting downlink signals to communication apparatus 310. Communication apparatus 310 may be able to receive a plurality of downlink data from the multiple panels. In order to properly transmit different downlink data, processor 322 may configure the multiple panels to transmit a plurality of downlink control signals to communication apparatus 310 to indicate the downlink data transmissions. Similarly, the downlink control signal may comprise a physical downlink control channel (PDCCH). The PDCCH may comprise the scheduling information including, for example and without limitation, quasi co-location (QCL) assumptions for antenna ports, modulation and coding scheme (MCS) levels, hybrid automatic repeat request (HARQ) indices, resource allocations, etc. Processor 322 may configure the multiple panels to use one single PDCCH or a plurality of PDCCHs to transmit all the scheduling information. Processor 322 may align or coordinate the PDCCH generation rules or mechanisms among the multiple panels to reduce the blind detection complexity at communication apparatus 310.

In some implementations, the wireless communication system may configure the multiple TRPs to send the same downlink control information (DCI) contents to communication apparatus 310 in the form of a plurality of PDCCH transmissions. Specifically, processor 312 may be configured to receive a first downlink control signal (e.g., a first PDCCH) from a first source (e.g., a first TRP). Processor 312 may also receive a second downlink control signal (e.g., a second PDCCH) from a second source (e.g., a second TRP). The contents of the first downlink control signal and the second downlink control signal may be identical and may indicate the resource allocation and the scheduling information of a plurality of downlink data. Processor 312 may be configured to receive the downlink data according to the first downlink control signal and the second downlink control signal.

In some implementations, processor 322 may be configured to transmit the downlink control signal in a determined control resource set. The control resource set may occupy a specific time-frequency region of resource elements. The wireless communication system may configure the first source (e.g. the first TRP) to transmit the first downlink control signal in a first control resource set. The wireless communication system may configure the second source (e.g. the second TRP) to transmit the second downlink control signal in a second control resource set. The first control resource set and the second control resource set may be identical or different. For example, in a case that the first control resource set and the second control resource set are identical, processor 312 may be configured to receive/decode the first downlink control signal (e.g., the first PDCCH) from the first source (e.g., the first TRP) and the second downlink control signal (e.g., the second PDCCH) from the second source (e.g., the second TRP) in the same occasion. In a case that the first control resource set and the second control resource set are different, processor 312 may be configured to receive/decode the first downlink control signal (e.g., the first PDCCH) from the first source (e.g., the first TRP) in a first occasion of a slot (e.g., symbol 0) and decode the second downlink control signal (e.g., the second PDCCH) from the second source (e.g., the second TRP) in a second occasion of the slot (e.g., symbol 2). The intermediate occasion (e.g., symbol 1) may be reserved for processor 312 to perform receiving beam adjustment.

In some implementations, the wireless communication system may configure processor 322 to send the same downlink control information (DCI) contents to communication apparatus 310 by using a plurality of panels in the form of a plurality of PDCCH transmissions. Similarly, processor 312 may be configured to receive a first downlink control signal (e.g., a first PDCCH) from a first source (e.g., a first panel). Processor 312 may also receive a second downlink control signal (e.g., a second PDCCH) from a second source (e.g., a second panel). The contents of the first downlink control signal and the second downlink control signal may be identical and may indicate the resource allocation and the scheduling information of a plurality of downlink data. Processor 312 may be configured to receive the downlink data according to the first downlink control signal and the second downlink control signal.

In some implementations, the wireless communication system may configure the multiple TRPs to send the downlink control signals to communication apparatus 310 in the same control resource set across the multiple TRPs in the form of a plurality of PDCCH transmissions. Specifically, processor 312 may be configured to receive a first downlink control signal (e.g., a first PDCCH) from a first source (e.g., a first TRP) in a first control resource set. Processor 312 may also receive a second downlink control signal (e.g., a second PDCCH) from a second source (e.g., a second TRP) in a second control resource set. The time-frequency region of the first control resource set and the second control resource set may be identical. The multiple TRPs may use the first downlink control signal and the second downlink control signal to indicate the resource allocation and the scheduling information of a plurality of downlink data. Processor 312 may be configured to receive the downlink data according to the first downlink control signal and the second downlink control signal. Processor 312 may only need to perform blind detection of PDCCH in one control resource set for the plurality of PDCCHs from different sources (e.g., different panels). The blind detection complexity of PDCCH may be reduced and simplified.

In some implementations, the wireless communication system may configure the multiple sources (e.g., multiple TRPs) to transmit identical downlink control signals or different downlink control signals to communication apparatus 310. For example, when the multiple sources (e.g., multiple TRPs) are configured with ideal backhaul, the multiple sources may be able to coordinate well and transmit the identical copies of the downlink control signals to communication apparatus 310. When the multiple sources (e.g., multiple TRPs) are not configured with ideal backhaul, the multiple sources may be independent from each other and may be configured to transmit different contents of the downlink control signals to communication apparatus 310. In a case that the first downlink control signal and the second downlink control signal are identical, processor 312 may receive/decode the same resource allocation and scheduling information for downlink data from different sources (e.g., different TRPs) in the same occasion. In a case that the first downlink control signal and the second downlink control signal are different, processor 312 may receive/decode different resource allocation and scheduling information for a plurality of downlink data from different sources (e.g., different TRPs) in the same occasion.

In some implementations, the wireless communication system may configure processor 322 to send the downlink control signals to communication apparatus 310 in the same control resource set across a plurality of panels in the form of a plurality of PDCCH transmissions. Similarly, processor 312 may be configured to receive a first downlink control signal (e.g., a first PDCCH) from a first source (e.g., a first panel) in a first control resource set. Processor 312 may also receive a second downlink control signal (e.g., a second PDCCH) from a second source (e.g., a second panel) in a second control resource set. The time-frequency region of the first control resource set and the second control resource set may be identical. Processor 322 may use the first downlink control signal and the second downlink control signal to indicate the resource allocation and the scheduling information of a plurality of downlink data. Processor 312 may be configured to receive the downlink data according to the first downlink control signal and the second downlink control signal. Processor 312 may only need to perform blind detection of PDCCH in one control resource set for the plurality of PDCCHs from different sources (e.g., different panels). The blind detection complexity of PDCCH may be reduced and simplified.

In some implementations, processor 312 may be able to use one DCI size to monitor a plurality of DCI types for reducing blind detection complexity. Specifically, processor 322 may use an indication in the downlink control signal (e.g., the first PDCCH or the second PDCCH) to indicate different DCI types. Processor 322 may use a bit field in the DCI of the downlink control signal as the indication. Processor 322 may use a reserved bit field or a new bit field of the DCI. Processor 322 may use the indication to indicate a specific DCI type. For example, the DCI type may comprise a first DCI type indicating that the downlink data transmission is transmitted from a single source (e.g., a single TRP or a single panel). The DCI type may further comprise a second DCI type indicating that the downlink data transmission is transmitted from multiple sources (e.g., multiple TRPs or multiple panels). Processor 322 may use the same DCI size for the first DCI type and the second DCI type. Accordingly, processor 312 may be able to monitor different DCI with the same DCI size. Processor 322 may use the bit field in the DCI to indicate whether a DCI corresponds to a first DCI type or a second DCI type. Processor 312 may be configured to detect the DCI of the downlink control signal according to the indication. Since the DCI size of different DCI types are the same, processor 312 may be able to perform blind detection by using the same DCI size.

### Illustrative Processes

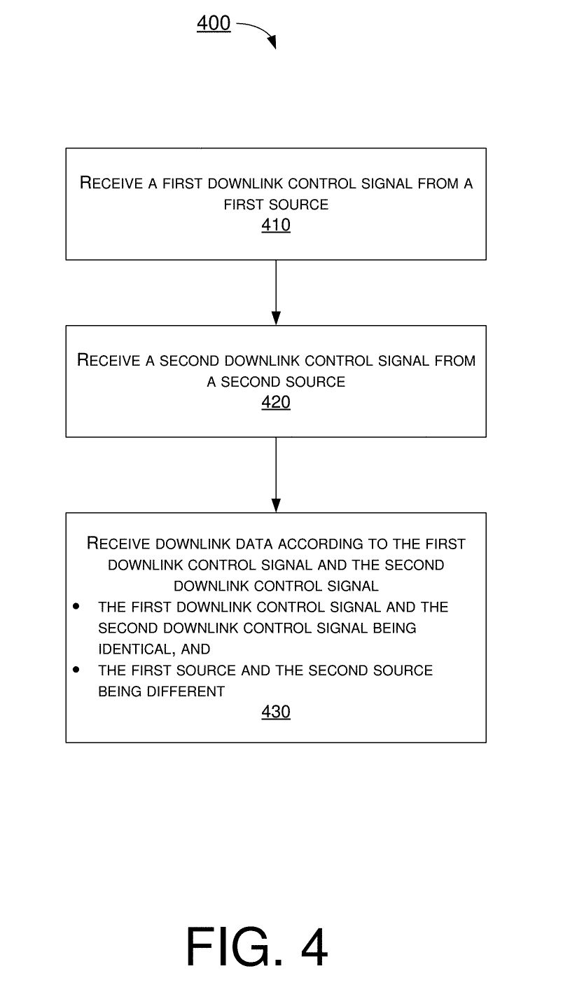

FIG. 4 illustrates an example process 400 in accordance with an implementation of the present disclosure. Process 400 may be an example implementation of scenarios 100 and 200, whether partially or completely, with respect to downlink control signal design in accordance with the present disclosure. Process 400 may represent an aspect of implementation of features of communication apparatus 310. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At 410, process 400 may involve communication apparatus 310 receiving a first downlink control signal from a first source. Process 400 may proceed from 410 to 420.

At 420, process 400 may involve communication apparatus 310 receiving a second downlink control signal from a second source. Process 400 may proceed from 420 to 430.

At 430, process 400 may involve communication apparatus 310 receiving downlink data according to the first downlink control signal and the second downlink control signal. The first downlink control signal and the second downlink control signal may be identical. The first source and the second source may be different.

In some implementations, the first downlink control signal may comprise a first physical downlink control channel (PDCCH). The second downlink control signal may comprise a second PDCCH.

In some implementations, the first source may comprise a first transmit/receive point (TRP). The second source may comprise a second TRP.

In some implementations, the first source may comprise a first panel of a network node. The second source may comprise a second panel of the network node.

In some implementations, the first downlink control signal may comprise a first control resource set. The second downlink control signal may comprise a second control resource set. The first control resource set and the second control resource set may be identical.

In some implementations, the first downlink control signal may comprise a first control resource set. The second downlink control signal may comprise a second control resource set. The first control resource set and the second control resource set may be different.

In some implementations, process 400 may involve communication apparatus 310 decoding the first PDCCH in a first occasion of a slot and decoding the second PDCCH in a second occasion of the slot.

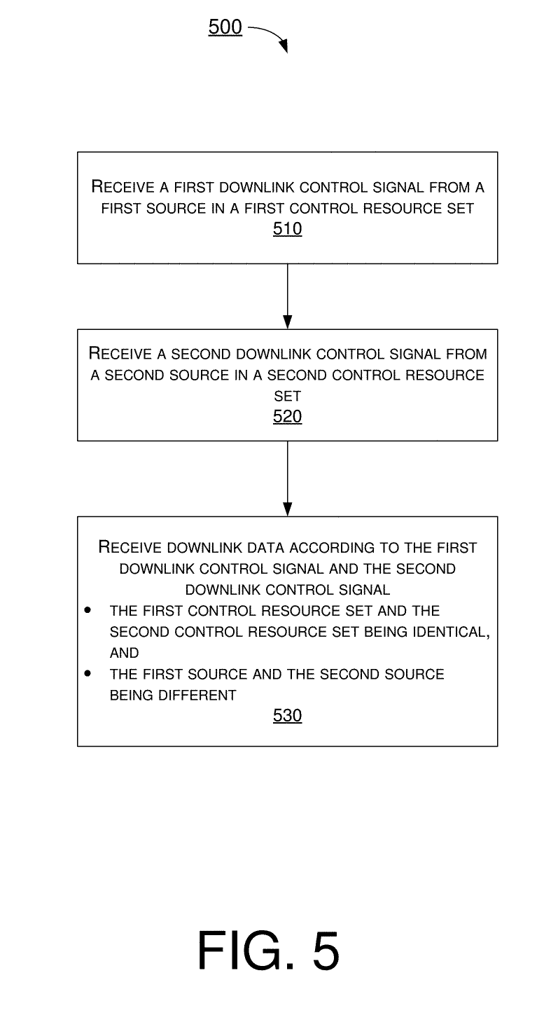

FIG. 5 illustrates an example process 500 in accordance with an implementation of the present disclosure. Process 500 may be an example implementation of scenarios 100 and 200, whether partially or completely, with respect to downlink control signal design in accordance with the present disclosure. Process 500 may represent an aspect of implementation of features of communication apparatus 310. Process 500 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by communication apparatus 310 or any suitable UE or machine type devices. Solely for illustrative purposes and without limitation, process 500 is described below in the context of communication apparatus 310. Process 500 may begin at block 510.

At 510, process 500 may involve communication apparatus 310 receiving a first downlink control signal from a first source in a first control resource set. Process 500 may proceed from 510 to 520.

At 520, process 500 may involve communication apparatus 310 receiving a second downlink control signal from a second source in a second control resource set. Process 500 may proceed from 520 to 530.

At 530, process 500 may involve communication apparatus 310 receiving downlink data according to the first downlink control signal and the second downlink control signal. The first control resource set and the second control resource set may be identical. The first source and the second source may be different.

In some implementations, the first downlink control signal may comprise a first physical downlink control channel (PDCCH). The second downlink control signal may comprise a second PDCCH.

In some implementations, the first source may comprise a first transmit/receive point (TRP). The second source may comprise a second TRP.

In some implementations, the first source may comprise a first panel of a network node. The second source may comprise a second panel of the network node.

In some implementations, the first downlink control signal and the second downlink control signal may be identical.

In some implementations, the first downlink control signal and the second downlink control signal may be different.

In some implementations, the first downlink control signal may comprise an indication to indicate a downlink control information (DCI) type. The indication may comprise a bit field in DCI. The bit field may comprise a reserved bit field or a new bit field in the DCI.

In some implementations, process 500 may involve communication apparatus 310 detecting DCI of the first downlink control signal according to the indication.

In some implementations, the DCI type may comprise a first DCI type indicating downlink data transmission from a single source. The DCI type may also comprise a second DCI type indicating downlink data transmission from multiple sources. The DCI size of the first DCI type may be same as the DCI size of the second DCI type.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a first downlink control signal from a first source;
receiving, by the processor, a second downlink control signal from a second source; and
receiving, by the processor, downlink data according to the first downlink control signal and the second downlink control signal,
wherein the first downlink control signal and the second downlink control signal are identical, and wherein the first source and the second source are different.

2. The method of claim 1, wherein the first downlink control signal comprises a first physical downlink control channel (PDCCH), and wherein the second downlink control signal comprises a second PDCCH.

3. The method of claim 1, wherein the first source comprises a first transmit/receive point (TRP), and wherein the second source comprises a second TRP.

4. The method of claim 1, wherein the first source comprises a first panel of a network node, and wherein the second source comprises a second panel of the network node.

5. The method of claim 1, wherein the first downlink control signal is transmitted in a first control resource set, wherein the second downlink control signal is transmitted in a second control resource set, and wherein the first control resource set and the second control resource set are identical.

6. The method of claim 1, wherein the first downlink control signal is transmitted in a first control resource set, wherein the second downlink control signal is transmitted in a second control resource set, and wherein the first control resource set and the second control resource set are different.

7. The method of claim 2, further comprising:
decoding, by the processor, the first PDCCH in a first occasion of a slot; and
decoding, by the processor, the second PDCCH in a second occasion of the slot.

8. A method, comprising:
receiving, by a processor of an apparatus, a first downlink control signal from a first source in a first control resource set;
receiving, by the processor, a second downlink control signal from a second source in a second control resource set; and
receiving, by the processor, downlink data according to the first downlink control signal and the second downlink control signal,
wherein the first control resource set and the second control resource set are identical, and wherein the first source and the second source are different.

9. The method of claim 8, wherein the first downlink control signal comprises a first physical downlink control channel (PDCCH), and wherein the second downlink control signal comprises a second PDCCH.

10. The method of claim 8, wherein the first source comprises a first transmit/receive point (TRP), and wherein the second source comprises a second TRP.

11. The method of claim 8, wherein the first source comprises a first panel of a network node, and wherein the second source comprises a second panel of the network node.

12. The method of claim 8, wherein the first downlink control signal and the second downlink control signal are identical.

13. The method of claim 8, wherein the first downlink control signal and the second downlink control signal are different.

14. The method of claim 8, wherein the first downlink control signal comprises an indication to indicate a downlink control information (DCI) type.

15. The method of claim 14, wherein the indication comprises a reserved bit field or a new field in DCI.

16. The method of claim 14, further comprising:
detecting, by the processor, DCI of the first downlink control signal according to the indication.

17. The method of claim 14, wherein the DCI type comprises a first DCI type indicating downlink data transmission from a single source.

18. The method of claim 17, wherein the DCI type further comprises a second DCI type indicating downlink data transmission from multiple sources.

19. The method of claim 18, wherein a DCI size of the first DCI type is same as a DCI size of the second DCI type.
